(19) United States
(12) Patent Application Publication
(10) Pub. No.: US 2012/0206997 A1
(43) Pub. Date: Aug. 16, 2012

(54) SOLAR POWERED MOLE AND GOPHER CHASER

(76) Inventor: Damian Krause, New York, NY (US)

(21) Appl. No.: 13/398,404

(22) Filed: Feb. 16, 2012

Related U.S. Application Data
(60) Provisional application No. 61/443,320, filed on Feb. 16, 2011.

(51) Int. Cl. H04B 1/02

(52) U.S. Cl. 367/139

(57) ABSTRACT

A pest repeller provided with a spring loaded contact system that removes the need for a fragile wire/connecting system and allows the use of replaceable rechargeable batteries without endangering the structural integrity of the device. An alternative embodiment provides an electrically conductive button that is screwed down onto the battery stack. In either embodiment, the spring loading or screw-down button correct for battery length variability by urging the battery chamber as well as the battery stack toward the contact points.

This invention is directed to a spring-loaded contact system for a solar powered pest deterrent with replaceable batteries.

### BACKGROUND OF THE INVENTION

In-ground devices that utilize sonic waves to disturb ground dwelling animals are known in the art. See, for example, U.S. Pat. Nos. 5,205,066; 5,822,917; 5,870,847; and 6,157,594.

Various problems have plagued prior art solar powered pest repellers. These problems arise from the components needed to transmit the power collected at the solar panel to the batteries. The way this has been accomplished in the prior art is through the use of a series of wires and connectors from the panel to the batteries. This wire-connector construction is fragile and easily breakable and systems which use replaceable batteries often became unusable because of the wires or connections being broken during battery replacement. In order to avoid that problem, prior art solar repellers were generally sealed such that the batteries cannot be replaced. Since the batteries, though rechargeable by the solar power, have a limited life, the sealed device becomes unusable and is discarded when the batteries finally die.

Another problem often found in battery powered devices is that due to the variability in battery lengths, arising from manufacturing differences or temperature changes, the battery stack is not long enough to reach the contacts or is too long, causing fitting problems. At those times, the device will not function.

The present invention overcomes these problems of prior art devices by providing a spring loaded contact system that removes the need for a fragile wire/connecting system and thus allows the use of replaceable rechargeable batteries without endangering the structural integrity of the device. An alternative embodiment provides an electrically conductive button that is screwed down onto the battery stack.

In either embodiment, the spring loading or screw-down button correct for battery length variability by urging the battery chamber as well as the battery stack toward the contact points.

### SUMMARY OF THE INVENTION

The present invention is an in-ground pest repeller that has a solar panel and a chamber holding replaceable batteries. The batteries are spring-loaded in the chamber so that the center button of the top battery makes electrical contact with a bulls-eye ring in the solar head. A second spring can urge the entire battery chamber toward the contacts on the device head or an electrically conductive button may be screwed down onto the battery stack. Electricity is generated at the solar panel on the head and conducted to a battery charging circuit.

### DESCRIPTION OF THE DRAWINGS

FIG. 1 is an elevation view of the exterior of a preferred embodiment of the present invention;

FIG. 2 is an exploded view thereof;

FIG. 3 is an internal view of the cap thereof;

FIG. 4A is a plan view of the top portion of the battery compartment which allows for direct contact of the battery button to the bulls-eye ring in the solar head;

FIG. 4B is a plan view of the top portion of the battery compartment having a conductive button at the top of the battery chamber;

FIG. 4C is a perspective view of the battery compartment of FIG. 4B with the conductive button removed;

FIG. 5 is an enlarged view of the motor end of the battery chamber thereof.

### DETAILED DESCRIPTION OF THE INVENTION

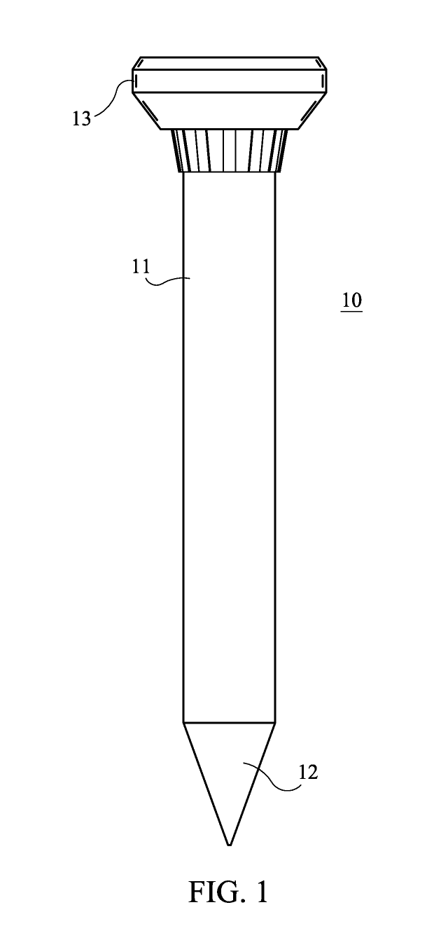

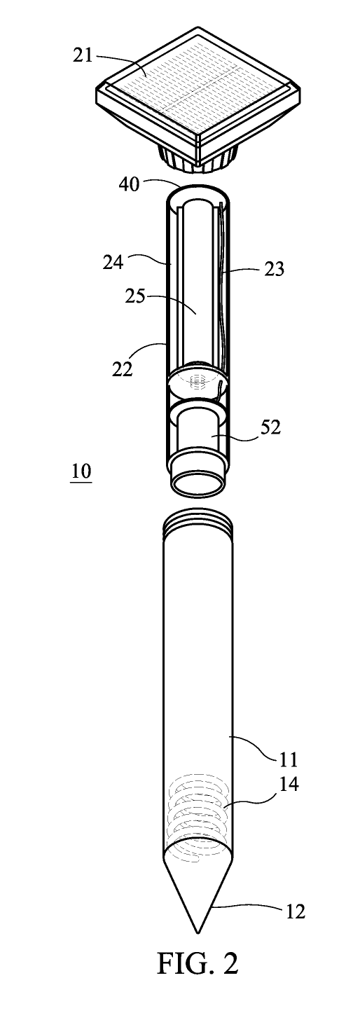

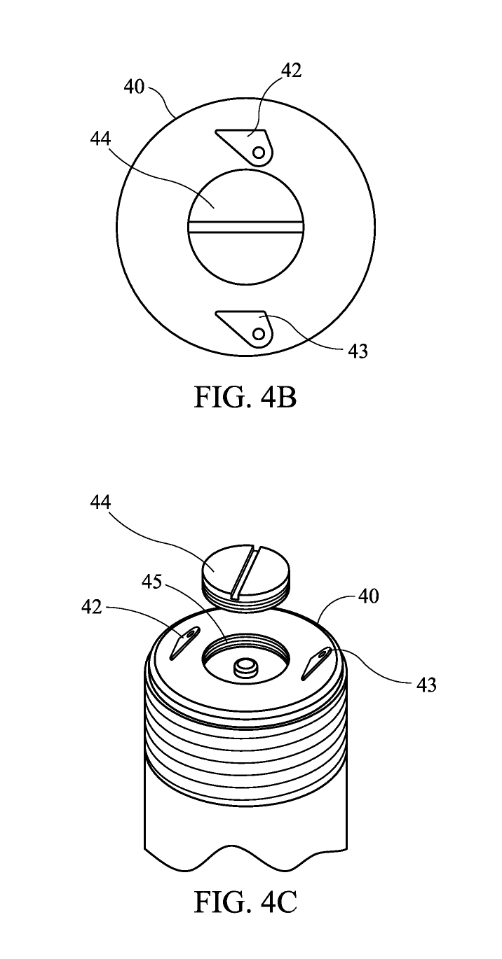

FIG. 1 shows the intact pest repeller 10 which is a cylindrical tube 11 having a pointed tip 12 and a head 13 having a solar panel 21, as shown in FIG. 2, mounted thereon. Within cylindrical tube 11 is battery chamber 22 having a channel 25 in which one or more replaceable batteries (not shown) are inserted. Attached to pointed tip 12 is spring 14 that fits within cylindrical tube 11. Spring 14 exerts upward pressure on battery chamber 22 and causes V-shaped contacts 42 and 43, shown in FIG. 4A on the top portion of battery sleeve 22, to contact conductive rings 33 and 30, respectively, of bulls-eye ring 32. Contacts 42 and 43 may be manufactured of spring steel to increase the spring loading effect.

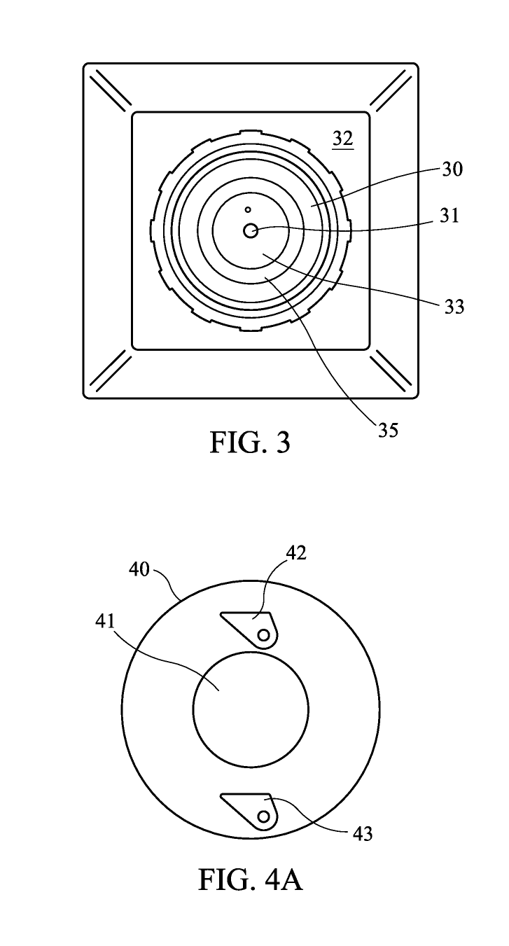

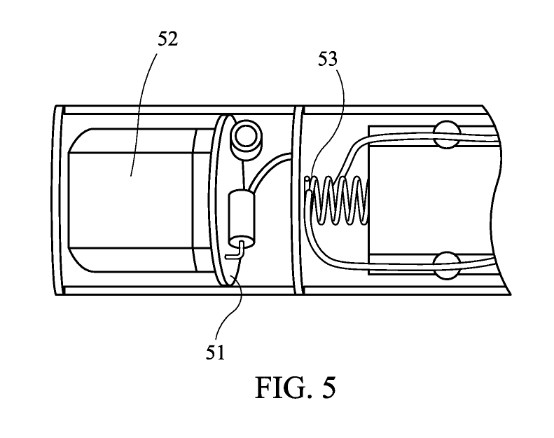

In one embodiment of the invention, spring 53, shown in FIG. 5, exerts additional upward pressure on batteries (not shown) within channel 25. The spring-loading action of spring 53 urges the top battery in chamber 25 to extend through opening 41, shown in FIG. 4A, so as to make contact with the center portion 31 of bulls-eye ring 32 found within head 13, as shown in FIG. 3.

In a second embodiment, shown in FIGS. 4B and 4C, the walls of opening 41 are lined with threading 45 such that a conductive button 44 may be threaded into hole 41 so that solid contact is made with the pole of the battery. In this embodiment, the battery will contact button 44, which will then contact the center portion 31 of bulls-eye ring 32.

When sunlight hits solar panel 21, electricity is generated and then transmitted from panel 21 by wires (not shown) to the conductive areas 30 and 33 and then via contacts 42 and 43 to wires 23 and 24 to a charging circuit on circuit board 51. The charging circuit charges the batteries which then power sound generator 52.

In a preferred embodiment, sound generator 52 produces a rattling sound that is transmitted through the tube to the surrounding earth from where it radiates outward, annoying and driving ground pests from the area.

1. A pest repeller comprising:
a tube having a tip at a first end and a head at a second end wherein a solar panel is mounted on an outside section of the head and is electrically connected to a plurality of electrically conductive areas located on an inner section of the head;
a battery chamber within the tube having a channel configured to hold at least one battery;
a first spring fit within the tube adjacent to the tip, which first spring exerts pressure on the battery chamber;
a sound generator located within the cylindrical tube;
an electrical circuit connecting the plurality of electrically conductive areas to the battery and the battery to the sound generator.

2. A pest repeller according to claim 1 wherein the electrically conductive areas are concentric.

3. A pest repeller according to claim 1 wherein a second spring is located within the battery chamber which exerts pressure on the battery.

4. A pest repeller according to claim 1 wherein a conductive button is screwed into a top portion of the battery chamber to contact a pole on the battery and wherein the conductive button is connected to the electrical circuit.

5. A pest repeller comprising:
a tube having a tip at a first end and a head at a second end wherein a solar panel is mounted on an outside section of the head and is electrically connected to a plurality of concentric electrically conductive areas located on an inner section of the head;
a battery chamber within the tube having a channel configured to hold at least one battery and wherein a second spring is located within the battery chamber which exerts pressure on the battery;
a first spring fit within the tube adjacent to the tip, which first spring exerts pressure on the battery chamber and a second spring is located within the battery chamber which exerts pressure on the battery;
a sound generator adjacent to the battery chamber;
an electrical circuit connecting the plurality of electrically conductive areas to the battery and the battery to the sound generator.

6. A pest repeller comprising:
a tube having a tip at a first end and a head at a second end wherein a solar panel is mounted on an outside section of the head and is electrically connected to a plurality of concentric electrically conductive areas located on an inner section of the head;
a battery chamber within the tube having a channel configured to hold at least one battery and wherein a conductive button is screwed into a top portion of the battery chamber to contact a pole on the battery;
a first spring fit within the tube adjacent to the tip, which first spring exerts pressure on the battery chamber;
a sound generator adjacent to the battery chamber;
an electrical circuit connecting the plurality of electrically conductive areas to the battery and the battery to the sound generator.

7. A pest repeller according to claim 6 wherein a second spring is located within the battery chamber which exerts pressure on the battery.
